(19) United States
(12) Patent Application Publication
(10) Pub. No.: US 2025/0280007 A1
(43) Pub. Date: Sep. 4, 2025

(54) Data Enrichment System

(71) Applicant: Amadeus S.A.S., Biot (FR)

(72) Inventors: Alexis RAVANEL, Antibes (FR); Ilias DRIOUICH, Nice (FR); Mourad BOUDIA, Valbonne (FR); Nicolas HAUVILLER, Valbonne (FR); David-Olivier SABAN, La Colle-sur-Loup (FR)

(21) Appl. No.: 18/640,428

(22) Filed: Apr. 19, 2024

(30) Foreign Application Priority Data
Apr. 21, 2023 (FR) 2304044

(51) Int. Cl. H04L 9/40; G06F 16/483

(52) U.S. Cl. CPC H04L 63/126; G06F 16/483

(57) ABSTRACT

Computer-implemented methods of data enrichment according to a characteristic, as well as systems and computer program products for enriching data according to a characteristic. The method uses data content from at least two data sources comprising at least one data type and comprises assigning a trust factor to a data source for the characteristic, preprocessing data received from the data source according to a data type, analyzing information comprised by the data with respect to the characteristic, and applying an enrichment process to select information for data enrichment related to the characteristic based on the analysis of the information and the trust factor.

### BACKGROUND

The present disclosure generally relates to data retrieval and processing in a distributed computing system, in particular, to data enrichment according to a characteristic using data content from at least two data sources comprising at least one data type.

Data retrieval and processing in a distributed environment faces many problems. When multiple data sources have to be searched for retrieving information, many problems arise. Different data sources may store different data types, provide different information content, and/or require different search parameters if they are searchable at all. Moreover, data sources may also differ in their trustworthiness in general or even particularly with respect to specific required information. Hence, data retrieval for end users can be time consuming as they have to find the data sources delivering the required content, search with different parameters or only visually search the data sources, install different programs for searching and the like. Additionally, end users may end up with wrong information due to a lack of trustworthiness of the data source or the content shared by the data source. Finally, an end user who is required to search multiple data sources (and may even not retrieve the relevant information from some of these) wastes a lot of computational and bandwidth resources.

For example, a traveler wants to search for experiences and services at a destination (e.g., tours, activities, attractions), and the current digital providers of customer facing information are either not travel-specific (e.g., Google Maps), not exhaustive (e.g., only related to the travel from/to the destination), or sometimes not accurate (e.g., platforms that depend on user reviews such as TripAdvisor™). Destination content is extremely fragmented and sometimes related information is outdated as it relies on the content owner's willingness and capability to update various sources/platforms. This makes it difficult for travelers to search for suitable activities.

Hence, from a time- and resource-consumption as well as accuracy perspective, there is a need for a data source that provides all relevant information to an end user. This can be achieved by a data enrichment process, which refers to the process of adding additional information or context to a dataset in order to improve its quality. However, a data enrichment process in a distributed environment is faced with the same problems as an end user searching for relevant information.

Hence, there is a need of an improved data enrichment process in a distributed environment.

### SUMMARY

According to a first aspect, a computer-implemented method of data enrichment according to a characteristic is provided. The method uses data content from at least two data sources comprising at least one data type and comprises assigning a trust factor to a data source for the characteristic, preprocessing data received from the data source according to a data type, analyzing information comprised by the data with respect to the characteristic, and applying an enrichment process to select information for data enrichment related to the characteristic based on the analysis of the information and the trust factor.

In some embodiments, at least one data type comprises one or more of text, structured information, image, sound, and video. In further embodiments, the trust factor reflects how trustworthy the data source is with respect to the characteristic. In yet further embodiment, the trust factor is determined based on a machine learning model that is continuously trained with data retrieved from the two or more data sources.

In some embodiments, preprocessing data comprises extracting content of the data by at least one of, a) for data type text: applying natural language processing for translation, correction, formatting, speech tagging, and/or feature extraction of the text, b) for data type structured information: organizing content according to tags, c) for data type image: applying at least one of object detection, face detection, object segmentation, and object recognition, d) for data type sound: applying speech recognition and/or natural language processing, and e) for data type video: applying at least one of object detection, face detection, speech recognition, and natural language processing.

In further embodiments, preprocessing data comprises extracting metadata of the data. In yet further embodiments, metadata comprises at least one of descriptive metadata relating to at least one of title, subject, genre, and author; rights metadata relating to at least one of title, copyright status, rights holder, and license terms; technical metadata relating to at least one of file types, size, creation date, creation time, type of compression, uniform resource locator, and page rank; preservation metadata relating to an item's place in a hierarchy or in a sequence; and picture metadata relating to at least one of a timestamp, camera properties, resolution, size, and geotag.

In some embodiments, analyzing information comprises at least one of a) for data type text: applying natural language processing for analyzing word similarity and/or sentiments of authors, b) for data type image: analyzing detected objects and/or faces with respect to at least one of facial expression, emotion, age, and gender, and c) for structured data type: discovering rules in the structure data.

In further embodiments, analyzing the information comprises determining a relevance score for the data with respect to the characteristic and a confidence value of the relevance score being correct.

In some embodiments, the enrichment process is based on a machine learning model, wherein input of the machine learning model comprises the relevance score for the data with respect to the characteristic, the confidence value of the information being correct, the trust factor of the data source of the information, a weight factor of the information, and a time stamp. In further embodiments, the input of the machine learning model comprises further information extracted from metadata. In yet further embodiments, the enrichment process to select information for data enrichment comprises determining a probability value for the information for data enrichment being correct and, in response to the probability value being higher than a threshold value, selecting the information.

In some embodiments, the method is triggered periodically and/or in response to a request for recommendation request concerning the characteristic.

According to a second aspect, a system of data enrichment configured to execute the method as described herein is presented.

According to a third aspect, a computer program product comprising program code instructions stored on at least one computer readable medium to execute the method as described herein is presented, when said program code instructions are executed on a computer.

### BRIEF DESCRIPTION OF THE DRAWINGS

The foregoing and further objects, features and advantages of the present subject matter will become apparent from the following description of exemplary embodiments with reference to the accompanying drawings, wherein like numerals are used to represent like elements, in which:

FIG. 1 presents an overview of a computer-implemented data enrichment method.

FIG. 2 shows a flow chart of an example or the data enrichment.

FIG. 3 depicts examples of data sources and contents.

FIG. 4A shows trust factors of data sources on a data type and characteristic level.

FIG. 4B shows trust factors of data sources on a characteristic level.

FIG. 5A presents an example of preprocessing of photo content.

FIG. 5B presents an example of processing of textual content.

FIG. 6A shows an example of analyzing the photo content after preprocessing.

FIG. 6B shows an example of analyzing the textual content after preprocessing.

FIG. 7 depicts an enrichment process.

FIG. 8 is a further detailed example of data enrichment according to the disclosure.

FIG. 9 shows a diagrammatic representation of a computing system implementing the functionalities described herein.

### DETAILED DESCRIPTION

The present disclosure relates to methods and systems of data enrichment according to a characteristic using data content from at least two data sources comprising at least one data type. Generally, data enrichment processes aim at enriching data of one data source, which may be stored in distributed databases or in one single database. In other words, data enrichment refers to the process of adding additional information or context to a dataset in order to improve its quality. Data enrichment may be an easy task when the information to be added is contained in one trustworthy data source that only comprises one data type.

However, in the current world, where information is distributed all over the internet having different data formats provided by different data sources, a data enrichment process is faced with many problems: How trustworthy is a data source and/or how trustworthy is this data source with respect to a specific characteristic to be searched for? What data types are provided and how to retrieve the relevant information for data enrichment? These questions are answered and the resulting issues are handled by the data enrichment method described herein.

It should be noted that although the present application describes the data-enrichment method in a travel-related context, the data enrichment process as described herein may be applied to everywhere where data enrichment from different data sources is needed.

In the travel industry, the applicability of the present disclosure is highly visible. The pandemic has reinforced two industry fundamentals around travel. First, travel has become deeply personalized. This means offering unique experiences to customers with different preferences is required. Second, each experience is considered by the traveler as an end-to-end journey, not a series of isolated events.

As a traveler, it is not always easy to find the information which will ease decision-making. A traveler may need to find whether the activity is suitable for specific categories, such as age (e.g., infants, teenagers, seniors), reduced mobility, or pets, whether the activity can be easily accessed by public transport, nearby parking, or with respect to languages spoken, whether the activity has specific characteristics, such as seasonality (e.g., outdoor only in summer), weather-dependency, equipment (needed to do the activity), emotions triggered, price range, conditions, recommended average visit time, popularity per country/culture, or is a good photo spot, whether the activity is similar to other activities, whether the trust level of the provider is high, or what the most representative photos of the activity are.

90% of travelers now seek personalized travel recommendations while planning their trip as time and resources are always an issue. Hence, travelers request hyper-personalized content based on their profile and interests. This hyper-personalization implies that travel providers need to understand their customers as microsegments, not as monoliths, i.e., go beyond business/leisure, family/solo travelers, and the like. The IT systems supporting travel providers have detailed and travel-related information about content which can be recommended to microsegments.

When it comes to recommending experiences and services at destination (tours, activities, attractions) to travelers, the current digital providers of customer information are either not travel-specific (e.g., Google Maps), not exhaustive (e.g., only related to the travel from/to the destination), or sometimes not accurate (e.g., those based on user reviews and recommendations such as TripAdvisor or Google Maps). Destination Content is extremely fragmented and sometimes related information is outdated as it relies on the content owner's willingness and capability to update various sources/platforms. This makes it difficult to leverage in a travel context or to deliver information to travelers or to recommend activities, respectively.

Embodiments of this disclosure describe processes for data enrichment with respect to destination content, such as shops, museums, activities. The processes leverage various sources and apply information extraction technics to provide travelers (e.g., via travel distributors) with up-to-date information, more details which are relevant to travelers, and/or information that is not accessible/visible to the user. The processes of the disclosure can be used to power a catalogue (listing of activities) or improve a recommendation engine.

This disclosure facilitates creating an enriched database of travel providers, which could be used as input of a recommender system or searched by travelers. However, any other enriched database can benefit from the disclosure as it is also described generally for any enrichment process. The enrichment categories in the travel industry may particularly relate to suitability (children, groups, pets, popularity, emotion triggered . . . ), accessibility (parking, transportation, disability, . . . ), seasonality and weather dependency, trust and up-to-date level, etc.

The advantages of the disclosure in a travel related context are omnipresent. One goal is the creation of an enriched and up-to-date catalogue of destination experiences. This is achieved by extracting new information from various sources of raw data, creating new elaborate information from the extracted information, and arbitrating when conflicting information is captured based on the data source trustworthiness (e.g. Provider Official Information says “not suitable for dogs” but customer pictures in TripAdvisor show pictures of dogs). With the help of the herein-described processes and systems, it is made possible to create a highly effective recommender system addressing the growing needs of hyper personalization.

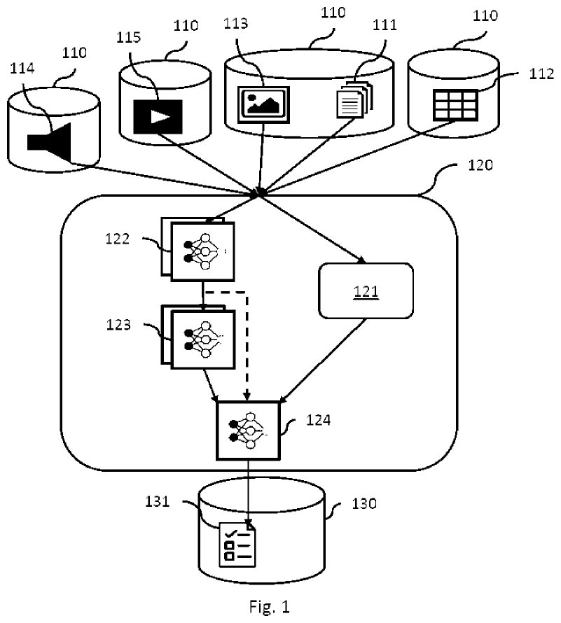

FIG. 1 presents an overview of a computer-implemented data-enrichment method and respective components. Main components presented therein are one or more input data sources 110, from which data is retrieved, a computing system 120 implementing the herein described data-enrichment method, and an output storage 130 that is enriched with information.

Data sources 110 comprise one or more data types, such one or more of text 111, structured information 112, image 113, sound 114, and video 115. For example, one data source 110 may provide textual content 111 in the form of natural language text, such as user reviews, forum discussion, or blog entries. Another data source 110 may provide structured information content 112 in the form of a standardized structure, an organizational structure, in HTML structure, or the like.

One single data source 110 may also provide two or more different data types, for example, textual content 110 and image or photo content 113. Images 113 may relate to user's images taken at a location or of an object, images accompanying a review, images painted, or the like. Sound content 114 may relate to music or other sound recordings, where no visual content is available. Video content 115 may also comprise sound but may also be soundless. Videos 115 may be provided for events and attractions, for support of installations, and such.

The computing system 120 comprises modules and components for different tasks. In particular, the computing system 120 comprises a trust module 121, one or more preprocessing modules 122, one or more analysis modules 123, and an enrichment module 124.

The trust module 121 is configured for assigning one or more trust factors to the one or more data sources 110 for a specific characteristic, respectively. A characteristic relates to a characteristic of an event, attraction, object, item, person, or the like. The characteristic may be evaluated to be relevant for data enrichment as it is important to know for end users. For example, if the data enrichment process is related to attractions, one characteristic that may be relevant for data enrichment is whether the attraction is suitable for dogs. Another characteristic may be whether the attraction is suitable for disabled or elderly people. Yet another characteristic may be whether the attraction can also be visited during stormy or rainy weather.

A trust factor may be a factor between 0 and 1 (or 0 and 100%) but may also be defined in any other range. A trust factor of 0 may represent a data source 110 that is not trustworthy when it comes to information related to the characteristic of “suitable for dogs”. A trust factor of 1 may indicate that the information of that data source 110 is absolutely trustworthy with respect to the selected characteristic. The trust factor may additionally also depend on the data type. For example, a data source 110 providing different data types may be assigned a different trust factor for each of the data types, e.g., one data source 110 providing text 111 and images 113 may have a trust factor of 0.9 for text for a characteristic and a trust factor of 0.8 for images for the same characteristic reflecting that textual content 111 from this data source is more trustworthy than for image content 113.

The trust factor may be determined, in some embodiments, by using a machine learning model. The machine learning model may be continuously trained with data retrieved from the data source(s) 110. Additionally or alternatively, the trust factor may be determined by a feedback loop mechanism. Such a mechanism may involve a human supervisor that validates the accuracy of the data or a data source, e.g., after a machine learning model or another model has determined a trust factor, through a user interface. The trust factor or accuracy assigned by the human supervisor may also be used as additional data sources to feed and train the machine learning algorithm.

The preprocessing module 122 is configured to preprocess the data received from the data source according to a data type. The data received from the data source is processed in terms of observations, i.e., a single group of data, e.g., relating to one textual content 111, such as one user's review, or one image content 113 one photo taken, and so on.

Preprocessing generally refers to extracting computer processable data for subsequent analysis. For example, for textual content 111, preprocessing may comprise applying natural language processing for translation, correction, formatting, speech tagging, and/or feature extraction of the text. For structured information 112, preprocessing may comprise organizing content according to tags. For images 113, preprocessing may comprise object detection, face detection, object segmentation, and/or object recognition. For data type sound 114, preprocessing may comprise applying speech recognition and/or natural language processing. For videos 115, preprocessing may comprise applying object detection, face detection, speech recognition, and/or natural language processing.

Preprocessing may additionally or alternatively also comprise extracting metadata of the retrieved data from the data sources 110. Metadata may comprises at least one of descriptive metadata relating to at least one of title, subject, genre, and author, rights metadata relating to at least one of title, copyright status, rights holder, and license terms, technical metadata relating to at least one of file types, size, creation date, creation time, type of compression, uniform resource locator, and page rank, preservation metadata relating to an item's place in a hierarchy or in a sequence, and picture metadata relating to at least one of a timestamp, camera properties, resolution, size, and geotag. The metadata may, for example, indicate whether a photo 113 or video 115 was recently taken and may be a current impression and may be taken at a specific location. The metadata of text 110 may indicate where and by whom the text was written.

Preprocessing may be achieved by applying several preprocessing modules 121, wherein one preprocessing module 122 applies one model, which is specific for a data type. There may also exist preprocessing modules 122 that preprocess multiple data types. One or more of the preprocessing modules 122 may be based on one or more machine learning models that have been trained according to the data type and the required data output. For example, a machine learning model may be trained to classify humans and/or animals in images 113. Another one, which may be used by the same preprocessing module 121, may be trained to find faces of humans or any predefined objects.

The preprocessed data is then processed by the analysis module 123. The analysis module 123 is configured to analyze information comprised by the preprocessed data with respect to the characteristic. For example, if the characteristic is “suitable for dogs”, the analysis module 123 may determine for one observation, e.g., one user's review, whether it comprises information about dogs.

Analyzing the information may differ with respect to the data type. For example, for text 111, analyzing the information may comprise applying natural language processing for analyzing word similarity and/or sentiments of authors. For data type image 113, analyzing the information may comprise analyzing detected objects and/or faces with respect to at least one of facial expression, emotion, age, and gender. For structured data 112, analyzing information may comprise type discovering rules in the structure data. Of course, applying natural language processing may also be applied for sound 114 and detecting faces with respect to at least one of facial expression, emotion, age, and gender may also be applied for videos 115. Basically, the same analyzing processes may be applied for different data types if suitable and known to the skilled person.

There may exist several analysis modules 123 with each being dedicated to one or more data types. One or more of the analysis modules 123 may be based on machine learning models. Additionally or alternatively, analyzing the information may comprise determining a relevance score for the data with respect to the characteristic and a confidence value of the relevance score being correct. The relevance score may be a value of the set {−1, 0, 1}, where −1 means not fulfilling the characteristic, 1 means fulfilling the characteristic, and 0 means no specific information with respect to the characteristic. Alternatively, the relevance score may also be any value in an interval [−1; 1] with a similar meaning as above. Other sets and intervals may be implemented as well. The confidence value may indicate how certain the analysis module 123 is with respect to the relevance score.

As an example, the analysis module 123 may implement a machine learning model for determining whether a photo, for which the preprocessing has revealed to show a dog, shows a relevant scene of the activity, e.g., the dog inside the museum or the like. If this is found relevant for the characteristic and that a dog is shown, the relevant score would be 1. The machine learning model may also indicate that this assessment is very certain, e.g., 89%.

Finally, the enrichment module 124 receives at least the outputs from the analysis modules 123 and the trust module 121. Additionally, the enrichment module 124 may also receive at least part of the output of the preprocessing module 122 as shown in FIG. 1 with a dashed line. The enrichment module 124 applies an enrichment process to select information for data enrichment related to the characteristic based on the analysis of the information and the trust factor.

For a given characteristic, information may be evaluated in the enrichment module 124 considering for each atomic source of information that can be provided by the other module comprised by the computing system 120, such as the predicted relevance score, the confidence value, the trust factor, and metadata, such as timestamps (creation or update information indicating freshness) or further extracted information comprised by the metadata.

In one embodiment, the enrichment module 124 may implement a machine learning model, wherein the input of the machine learning model comprises the relevance score for the data with respect to the characteristic, the confidence value of the information being correct, the trust factor of the data source of the information, a weight factor of the information, and a time stamp. This information is provided for each observation that is processed. The weight factor may be a weight assigned to the observation. For example, the weight factor may be higher for one data type, e.g., textual content 111, than another data type, e.g., sound 114.

The enrichment process may additionally or alternatively comprise determining a probability value for the information for data enrichment being correct. For example, a machine learning model may be trained to evaluate, based on information to a set of observations from different data sources and having different data types, whether the characteristic is fulfilled or not and then determine a probability value that reflects how sure the machine learning model is that characteristic is fulfilled or not. For example, if the characteristic is “suitable for dogs”, the machine learning model may determine that most of the data sources and observations indicate that this is “TRUE” for this activity, the output of the enrichment process may be a probability of 79% that this “TRUE”-information is correct.

In response to the probability value being higher than a threshold value, the enrichment process may comprise selecting the information for data enrichment. In the example above, the threshold value may be assumed to be 75%, i.e., only if the machine learning model is more than 75% certain about its decision, data 131 belonging to the activity in the output storage 130 will be enriched. This means, if the machine learning model returns 79%, the data belonging to the respective activity (e.g., name, address, conditions etc. provided by the owner of the activity) may be enriched with the information “suitable for dogs: yes”.

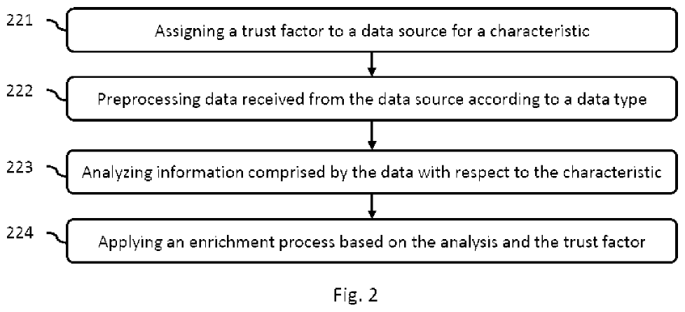

Although FIG. 1 shows many components and modules, not all are required to implement the basic method, which is shown in FIG. 2, as is known by the person skilled in the art. FIG. 2 starts with assigning a trust factor to a data source for a characteristic in box 221. The trust factor can be assigned in different ways, by humans or models, such as machine learning or traditional models. The trust factor reflects how trustworthy a data source 110 with respect to the characteristic is. The method proceeds with box 222 that relates to preprocessing data received from the data source 110 according to a data type. Receiving is to be understood broadly and may comprise pushing or pulling of data, requesting data, or accessing the data source.

Thereafter, the method analyses information comprised by the data with respect to the characteristic in box 223. The analysis may be based solely on the preprocessed data but may also use the original data as input. Finally, the method applies, in box 224, an enrichment process based on the analysis and the trust factor. In some embodiments, further data may be considered, too, e.g., data output of the preprocessing of box 222 or the original data. Although the boxes 221, 222, 223, and 224 are shown in a sequential order, the process of assigning a trust factor to a data source may also be processed in parallel to or independent of the execution of the boxes 222 and 223.

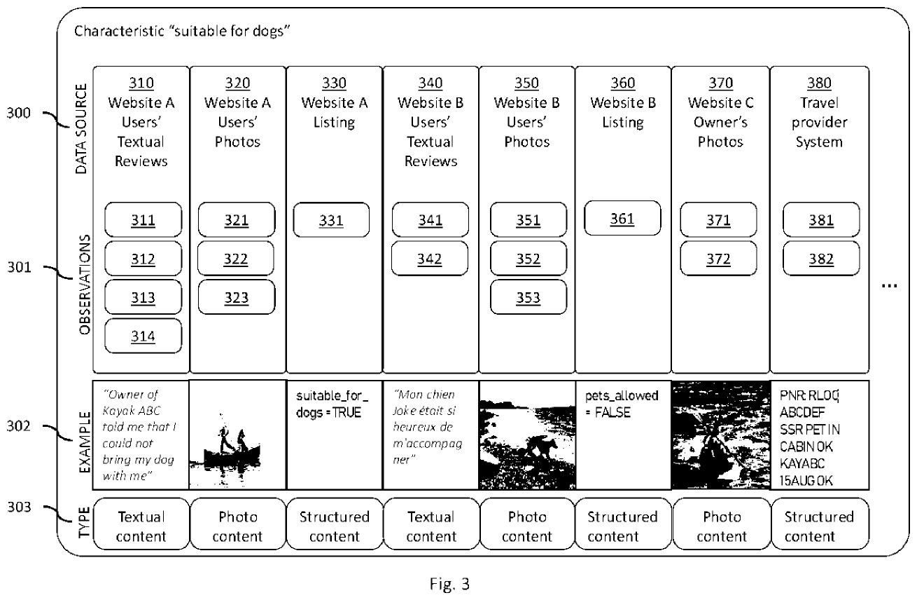

FIG. 3 depicts examples of data sources 300, such as the data sources 110, that store different data types 303. The data is organized in observations 301, which are data groups that belong to one entry, e.g., one user review, one photo or the like. For each data source 300, one observation 301 is highlighted as example 302. The selected characteristic is “suitable for dogs” and the activity is Kayak ABC, e.g., a kayak adventure.

Website A provides three data types, textual reviews 310, photos 320, and the listed information 330 about the activity. For textual content, there are four observations 311, 312, 313, 314 available, for photo content, there are three observations 321, 322, 323 available, and for structured content, there is one observation 331 available. Website B also provides three data types, textual reviews 340, photos 350, and the listed information 360 about the activity. For textual content, there are two observations 341, 342 available, for photo content, there are three observations 351, 352, 353 available, and for structured content, there is again one observation 361 available. Website C also provides one kind of information, namely, the owner's photos 370 for which two observations 371, 372 are available. Finally, a travel provider system may provide structured content 380 with two observations 381, 382.

The example of Website A's Users' Textual Reviews 310 shows a textual review in English, whereas the example of Website B's Users' Textual Reviews 340 shows textual review in French. Hence, the language may differ. Text is further often misspelled, has exotic grammar and may comprise fantasy words. For the algorithm to work, such text must be transformed to one common and clean standardized language.

The example of Website A's Users' Photos 320 shows a dog in a kayak. This is a good example that it seems likely that the dog is allowed to take part in the adventure. In contrast, Website B's Users' Photos 350 example only shows the dog on the coast and Website C's Owner's Photos 370 does not show a dog at all. The herein presented method and system is able to extract this information to make a decision on whether the activity is suitable for dogs.

The examples of Website A's and Website B's listings 330, 360 as well as of the travel provider system's database content 380 show that structured data may also differ. Hence, it is not trivial to extract the relevant information from structured data per se.

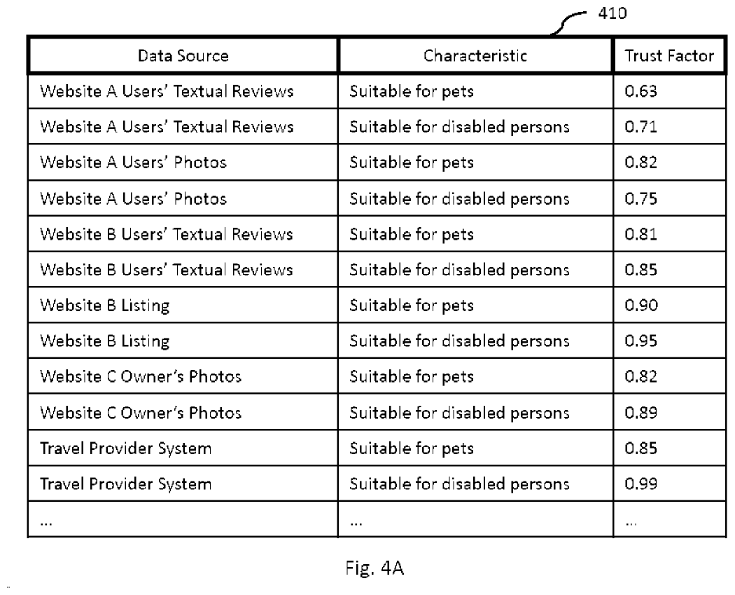

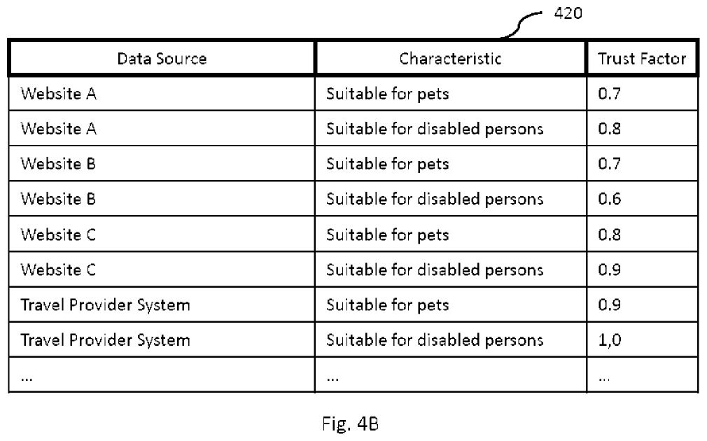

FIGS. 4A and 4B show listings of trust factors. FIG. 4A shows trust factors of data sources on a data type and characteristic level. In table 410, it can be seen that the Websites A and Website B provide two kinds of data types each. The trust factors for a characteristic differs for the data types. For example, the trust factor of Website A's textual content for the characteristic “suitable for pets” is 0.63, whereas the trust factor of Website A's image content for the same characteristic is 0.82. Assigning a trust factor individually for each data source and individually for the characteristic and for the data type allows a more granular assigning of trust factors. Moreover, the trustworthiness of one data type may fundamentally differ on one data source, such that such a trust factor as shown in table 410 may be advantageous when it comes to reliability of the data enrichment later.

FIG. 4B shows trust factors of data sources on a characteristic level. Here, it can be seen in table 420 that Website A has been assigned two trust factors, namely, 0.7 for the characteristic “suitable for pets” and 0.8 for the characteristic “suitable for disabled persons”. Website B, Website C, and the Travel Provider System also have each different trust factors for each characteristic. However, in contrast to table 410 of FIG. 4A, there is no differentiation between the data types. This reduces the computational effort for assigning trust factors compared to the trust factors of table 410. Moreover, the trust factor in table 420 is coded with only one decimal place whereas the trust factor in table 410 has two decimal places, which further reduces the memory needed for storage.

A trust factor per characteristic may be computed for a data source once and may be regularly refreshed using machine learning models trained based on the information provided by the data source. In some examples, the model training may also incorporate a “ground truth”, which reflects a real value of accuracy of a data source captured by another model or a human supervisor.

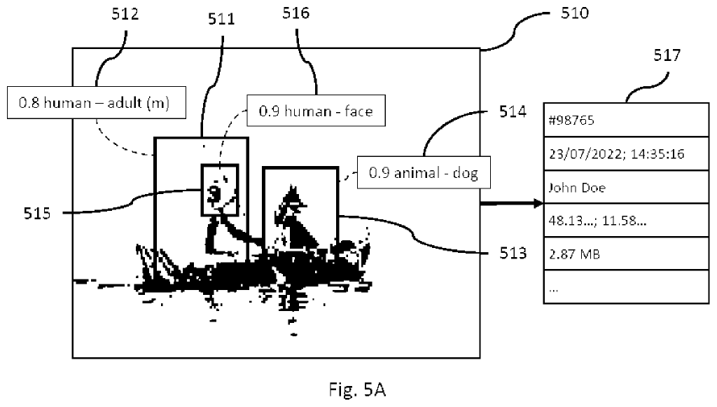

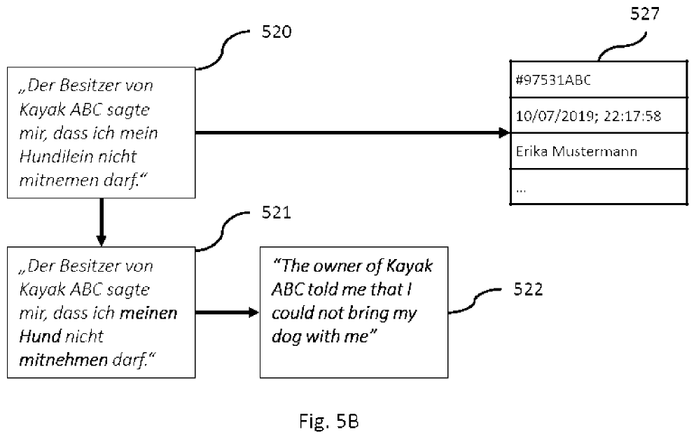

FIGS. 5A and 5B present examples of preprocessing raw data content from data sources, such as data sources 110. FIG. 5A presents an example of preprocessing of photo content, such as the photo content 113. A photo 510 of a man and a dog in a kayak is shown. The photo 510 may be processed by one or more machine learning model for object detection/segmentation/recognition or the like. Object detection on images uses computer vision and may assign a probability as is explained in the following.

The machine learning model may detect a human in bounding box 511 and categorize the human as being a male adult as shown in box 512. The same or another machine learning algorithm may also detect an animal with bounding box 513 and categorize the animal as dog as shown in box 514. The same or again another machine learning algorithm may also detect the man's face in bounding box 515 and may categorize this as a human's face as shown in box 516. The face may also be cropped and rescaled during preprocessing so that a later processing is facilitated. Machine learning models may also output probability scores depending on object probability, e.g., number of objects, nature, segmentation size etc.) as well similarity scores.

Moreover, preprocessing may also comprise extracting metadata 517 from the photo. Photo metadata may comprise at least one of a timestamp, camera properties, resolution, size, and geotag. In the example of FIG. 5A, metadata comprises (from up to down) a unique ID of the photo, a timestamp, an author of the photo, a geotag of the photo, the size of the photo, and further information indicated by three dots.

FIG. 5B presents an example of processing of textual content, such as textual content 111. The user's review of 520 is written in German and comprises misspelling and fantasy words. Preprocessing may first correct the misspellings and fantasy words as shown in bold in box 521. Afterwards, the text may be translated in English for following processing as is shown in box 522. Of course, text may also be first translated and then corrected and both preprocessing stages may be implemented by one or more machine learning algorithms. On top of this cleaning and translation, some characteristics of the text can be computed, such as name entity recognition, speech tagging and the like.

Speech tagging matches word and grammatical part of speech depending on the definition and context, e.g., “she (PREP) eats (VERB) chicken (NOUN)”. The text may also be filtered so that only nouns are kept, e.g., “bakery bakes bread”=>“bakery, bread”. Additionally or alternatively, similarity of text with keywords may be computed, e.g., “similarity(boat, kayak)=high”.

Moreover, preprocessing may also comprise extracting metadata 527 from the user's review. Textual metadata may comprise at least one of title, subject, genre, and author, rights metadata relating to at least one of title, copyright status, rights holder, and license terms. In the example of FIG. 5B, metadata comprises (from up to down) a unique ID of the user's review, a timestamp, an author of the text, and further information indicated by three dots.

Metadata of any data type may also comprise at least one of technical metadata relating to at least one of file types, size, creation date, creation time, type of compression, uniform resource locator, and page rank, and preservation metadata relating to an item's place in a hierarchy or in a sequence. Which metadata is extracted may be defined individually for each preprocessing module and may depend on the data type and on which data is required for which characteristic.

Other data types may require different preprocessing. For example, in travel industry, a PNR contains booking information. The booking information may comprise the travel and local activities. The structured data of a PNR may be preprocessed so that data is extracted that is relevant for data enrichment and other data, e.g., of the travel as such, is omitted. For example, data relating to pets, such as “pet in cabin” may be extracted but other data, such as flight number or the like, may be omitted. In another example, video content may be preprocessed such that single images are extracted, wherein the images are further preprocessed as described before with respect to FIG. 5A. Sound data may be preprocessed by applying speech recognition and speech-to-text algorithms. Hence, multiple different preprocessing variants may be applied in a data enrichment system that is capable of processing data from a plurality of data sources providing a plurality of data types.

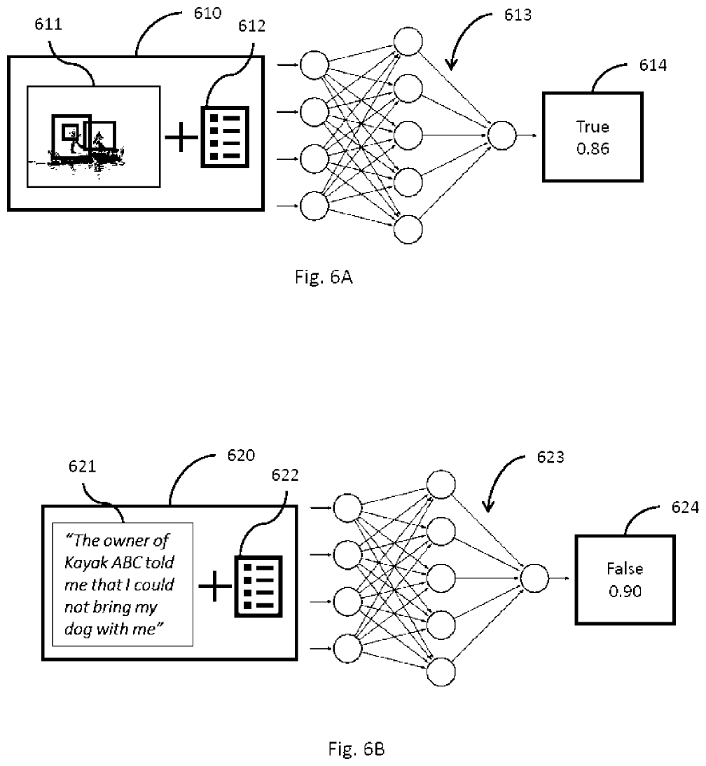

FIGS. 6A and 6B show examples of analyzing the information of different data types according to embodiments of the disclosure. FIG. 6A shows an example of analyzing the photo content after preprocessing. For each preprocessed observation as shown in box 610 with the preprocessed image 611 and the metadata 612, a machine learning model 613 may be applied. The input may be, e.g., at least one classification(s) of objects found in the image, image crops, at least part of the extracted metadata, and the like. The input is processed, e.g., by analyzing detected objects and/or faces with respect to at least one of facial expression, emotion, age, and gender.

The machine learning model 613 may be a supervised or semi-supervised model. The machine learning model 613 may be one of a gradient boosted tree, a random forest, and artificial neural network, a recurrent neural network, a convolutional neural network, an autoencoder, a deep learning architecture, a support vector machine, a data-driven trainable regression model, a k-nearest-neighbor classifier, a physical model and/or a decision tree or a combination thereof. The machine learning model 613 may be trained on the received data from the one or more data sources 110.

The output of the machine learning model 613 may be a relevance score for the data with respect to the characteristic and a confidence value of the relevance score being correct. In the example of FIG. 6A, the relevance score is “TRUE”, which means that the image shows relevant information for “suitable for dogs” with the answer being “yes, it's suitable for dogs”. This is because the photo shows a man with his dog in a kayak. The machine learning algorithm is also quite certain that this assessment is correct, indicated with a confidence value of 0.86 (=86%).

FIG. 6B shows an example of analyzing the textual content after preprocessing. For each preprocessed observation as shown in box 620 with the preprocessed text 621 and the metadata 622, a machine learning model 623 may be applied. The input may be, e.g., at least one of the preprocessed text, extracted words of the text, at least part of the extracted metadata, and the like. The input is processed, e.g., by applying natural language processing for analyzing word similarity and/or sentiments of authors.

The machine learning model 623 may be a supervised or semi-supervised model. machine learning model 623 may be one of a gradient boosted tree, a random forest, and artificial neural network, a recurrent neural network, a convolutional neural network, an autoencoder, a deep learning architecture, a support vector machine, a data-driven trainable regression model, a k-nearest-neighbor classifier, a physical model and/or a decision tree or a combination thereof. The machine learning model 623 may be trained on the received data from the one or more data sources 110.

The output of the machine learning model 623 may be a relevance score for the data with respect to the characteristic and a confidence value of the relevance score being correct. In the example of FIG. 6B, the relevance score is “FALSE”, which means that the image shows relevant information for “suitable for dogs” with the answer being “no, it's not suitable for dogs”. This is because the text indicates that the dog was not allowed in this activity. The machine learning algorithm is certain that this assessment is correct, indicated with a confidence value of 0.90 (=90%). This high value may be due to that the “owner” is mentioned in the text, which was determined based on trained keywords.

In such travel related examples, these machine learning models 613, 623 create the most elaborated information possible. Therefore, they may aggregate information coming from multiple sources and multiple domains, learn on unlabeled data (and apply clustering or self-supervised algorithms), and incorporate prior knowledge (e.g., Bayesian algorithms). Some typical tasks of these machine learning models 613, 623 are, e.g., a sentiment analysis performed to evaluate the users' perceptions of the activity and the service around or an identification of interesting entities in the images, or relevant actions performed in videos. In some embodiments, the machine learning models may reproduce human analysis in a scalable way, may lead to results not ‘computable’ by humans, or may lead to results that can be computed by humans but with a super-human performance.

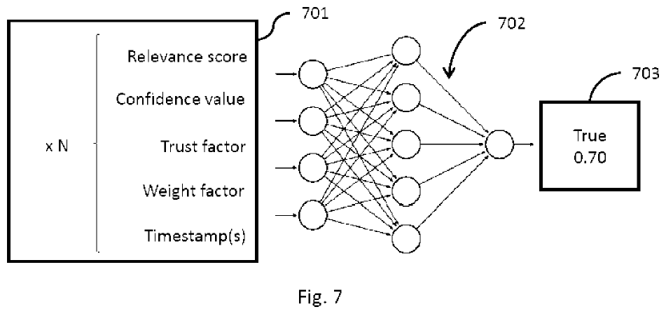

Although FIGS. 6A and 6B show only one machine learning network to be applied on a preprocessed observation, the analysis may consist of a sequence of machine learning models or several machine learning models applied in parallel. Moreover, in some embodiments, the output of several machine learning models as well as other models may be combined for assessing the relevance score and the confidence value. The output of the analysis modules and processes it then used by the enrichment process, of which FIG. 7 presents an example.

FIG. 7 depicts an enrichment process that uses a machine learning model 702 for determining whether information should be used for enriching stored data with respect to the selected characteristic. In this example, the input 701 at least consists of five values for each of N observations, namely, the relevance score and the confidence value determined by the analysis, the trust factor, the weight factor and the timestamp. In other example, more input values may be selected, e.g., other values extracted from metadata.

N is an integer number and indicates the number of observations received from the one or more data sources. In some embodiments, N is predefined, which means that always the observations are grouped by N observations. N may be chosen according to the processing power available. If more than N observations are received from the data sources, the outcome of the enrichment processes may then be combined, e.g., evaluated by forming mean values or the like. If less than N observations are received, the “missing” values may be filled with mean values of the other observations.

The machine learning model 702 may be a supervised or semi-supervised model. The machine learning model 702 may be one of a gradient boosted tree, a random forest, and artificial neural network, a recurrent neural network, a convolutional neural network, an autoencoder, a deep learning architecture, a support vector machine, a data-driven trainable regression model, a k-nearest-neighbor classifier, a physical model and/or a decision tree or a combination thereof. The machine learning model 702 may be trained on the preprocessed data.

The machine learning model 702 may process the input (in the size of N×5) to determine which information with respect to the characteristic may be added, e.g., in the example of FIG. 7 the information “TRUE”, and a probability value for the information for data enrichment being correct, e.g., in the example of FIG. 7 the probability value of 0.7 (=70%). If the probability value is higher than a threshold value, the information is selected for data enrichment. For example, if the enrichment process determines that Kayak ABC is suitable for dogs (i.e., “true”) with a probability of 70% and if the threshold value is set to 60%, the data stored in the database, which is to be enriched, is enriched with the information that Kayak ABC is suitable for dogs.

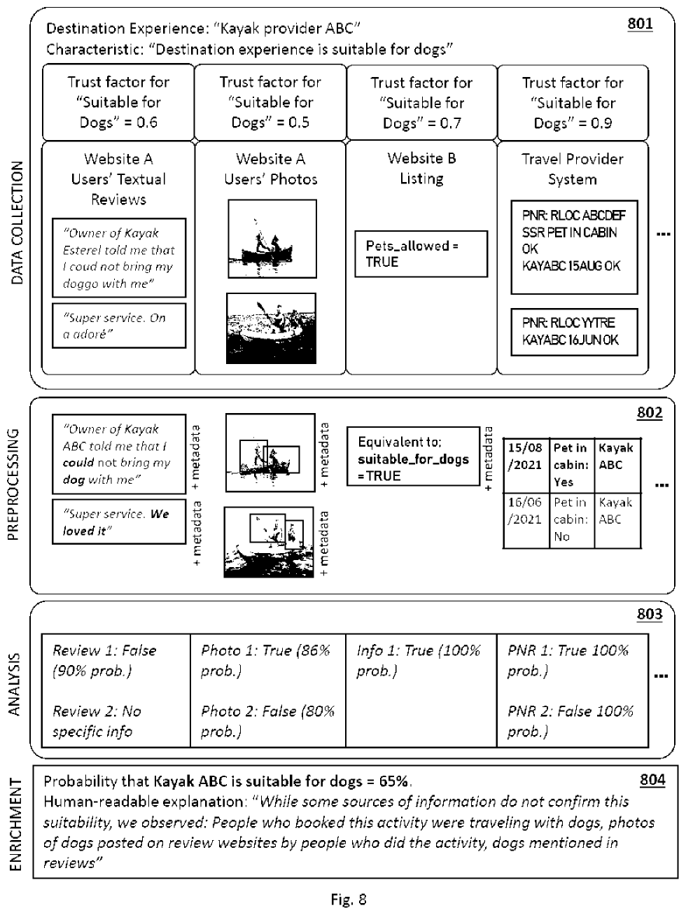

The interplay of all components is illustrated in FIG. 8, which is a further detailed example of data enrichment. In this example, the first box 801 shows the data or observations, respectively, which is available from three data sources, namely, Website A, Website B, and Travel Provider System. Moreover, box 801 also already indicates the trust factor that has been determined for each of the data sources. As can be seen in FIG. 8, the trust factor is not only dependent on the data source as such but also on the data type (Website A's textual content is rated with a trust factor of 0.6, whereas Website A's photo content is rated with a trust factor of 0.5). Box 801 also shows the raw data of each observation before preprocessing.

Box 802 then depicts what is the outcome after preprocessing. For example, the structured data of Website B's listing has been transferred to a common structure. The structured data of the Travel Provider System has also been brought in another structure, namely, a table comprising the relevant information (here particularly “Pet in Cabin”).

In box 803, the outcome of the analysis is shown. For example, the second user review of Website A, which does not mention dogs at all, is indicated as not providing specific information. In some embodiments, this information will not serve as input for the enrichment process. This means, irrelevant observations will be filtered so that less computational power is required as less data is to be processed by the enrichment process.

Finally, box 804 shows what the outcome of the enrichment process is, namely, that Kayak ABC is suitable for dogs with a probability of 65%. This probability may be too low so that no data enrichment in the stored data, e.g., stored in the output storage 130, is performed. A high threshold ensures that end users are not provided with false information. In this embodiment, a human-readable explanation may also be provided so that a human supervisor will know why or why not a data enrichment was executed.

As will be apparent to the persons skilled in the art, no limitation is present as to which characteristics are considered. For example, characteristics with respect to parking facilities may relate to parking difficulty, vehicle categories, height limit, indoor/outdoor parking, number of parking spots, valets, public, price, facilities (electricity, water for mobile homes . . . ), crowded parking times, time limits, distance to provider (Manhattan distance), and the like. The preprocessing and/or analysis processes may then comprise, for images, object detection (cars, boundaries, . . . ), object segmentation (parking spots . . . ) and the computation of weighted sums and other models, and for text, language translation, misspelling correction, formatting, feature extraction, word similarity detection, and/or sentiment analysis on reviews.

As another example, a characteristic with respect to a good photo spot may indicate whether there is a good picture to take for social networks or whether this is a common photo spot. In such an example, the preprocessing and/or analysis processes may take metadata of pictures and cluster them to find main attraction points.

Characteristics relating to weather (rain, wind, etc.) and or seasonality (winter, summer, etc.) may involve a detection of outdoor pictures and natural language processing (language translation, misspelling correction, formatting, feature extraction, . . . ) as preprocessing and natural language processing (word similarity, sentiment analysis on reviews, . . . ), hard coded rules and word embedding (kayak=outdoor?), as well as statistics on timestamps as analysis.

A characteristic may also relate to a similarity of one point of interest to another. This may be achieved, during preprocessing and/or analysis) by applying Siamese networks on images, word embeddings on textual reviews and other classic metrics on the metadata.

Moreover, the weight factor may not only depend on the data type but also differ within a data type. For the users' reviews, the weight factor can consider the reviewer characteristics and behavior. A score may be computed that characterizes the reviewer neutrality. For example, a traveler who only provides negative reviews is less credible compared to a balanced traveler. Frequency of reviewing may also be considered. For example, travelers who regularly provide feedback have more weight than travelers who have submitted very few reviews. Additionally or alternatively, travelers who provide complete/detailed reviews with pictures can have more weight. Natural language processing and sentiment analysis may also be used to evaluate reviews provided by the same traveler.

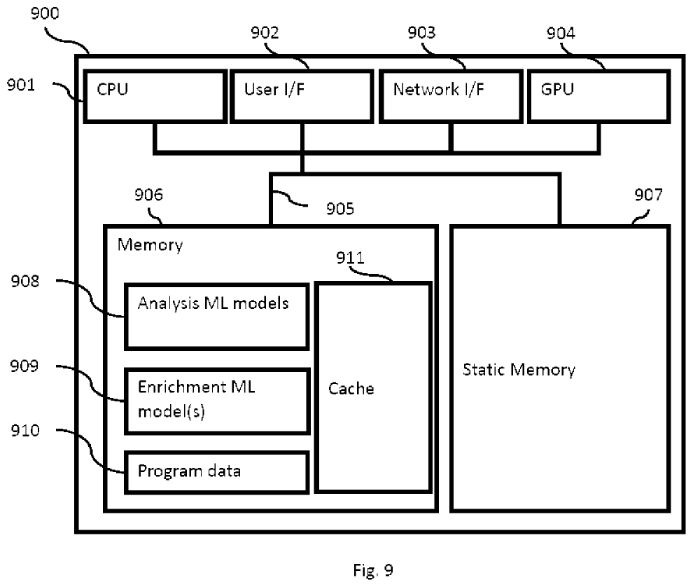

FIG. 9 is a diagrammatic representation of internal components of a computing system 900 implementing the functionality as described herein. The computing system 900 includes at least one processor 901, a user interface 902, a network interface 903 and a main memory 906, that communicate with each other via a bus 905. Optionally, the computing system 900 may further include a static memory 907 and a disk-drive unit (not shown) that also communicate with each via the bus 905. A video display, an alpha-numeric input device and a cursor control device may be provided as examples of user interface 902. Furthermore, the computing system 900 may also comprise one or more graphics processing units (GPU) 904.

The GPUs 904 may also comprise a plurality of GPU cores or streaming multiprocessors, which comprise many different components, such as at least one register, at least one cache and/or shared memory, and a plurality of ALUs, FPUs, tensor processing unit (TPU) or tensor cores, and/or other optional processing units.

The main memory 906 may be a random-access memory (RAM) and/or any further volatile memory. The main memory 906 may store program code for the functionalities as described herein. In particular, the main memory 906 may store data for machine learning models 908 that are applied for the analysis of the data as well as machine learning model(s) 909 for the enrichment processes as described herein. Other modules needed for further functionalities described herein, such as for preprocessing and data retrieval, may be stored in the memory 906, too. The memory 906 may also store additional program data 910 required for providing the functionalities described herein. Part of the program data 910 and/or machine learning models 908, 909 may also be stored in a separate, e.g., cloud memory and executed at least in part remotely. The main memory 906 may also comprise a cache 911 to store, e.g., the output of the machine learning models 908 that are used as input for the machine learning model 909 or the like.

According to an aspect, a computer program comprising instructions is provided. These instructions, when the program is executed by a computer, cause the computer to carry out the methods described herein. The program code embodied in any of the systems described herein is capable of being individually or collectively distributed as a program product in a variety of different forms. In particular, the program code may be distributed using a computer readable storage medium having computer readable program instructions thereon for causing a processor to carry out aspects of the embodiments described herein.

Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer.

A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

It should be appreciated that while particular embodiments and variations have been described herein, further modifications and alternatives will be apparent to persons skilled in the relevant arts. In particular, the examples are offered by way of illustrating the principles, and to provide a number of specific methods and arrangements for putting those principles into effect.

In certain embodiments, the functions and/or acts specified in the flowcharts, sequence diagrams, and/or block diagrams may be re-ordered, processed serially, and/or processed concurrently without departing from the scope of the disclosure. Moreover, any of the flowcharts, sequence diagrams, and/or block diagrams may include more or fewer blocks than those illustrated consistent with embodiments of the disclosure.

The terminology used herein is for the purpose of describing particular embodiments only and is not intended to be limiting of the embodiments of the disclosure. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “include”, “having”, “has”, “with”, “comprised of”, or variants thereof are used in either the detailed description or the claims, such terms are intended to be inclusive in a manner similar to the term “comprising”.

While a description of various embodiments has illustrated the method and while these embodiments have been described in considerable detail, it is not the intention of the applicants to restrict or in any way limit the scope of the appended claims to such detail. Additional advantages and modifications will readily appear to those skilled in the art. The disclosure in its broader aspects is therefore not limited to the specific details, representative apparatus and method, and illustrative examples shown and described. Accordingly, the described embodiments should be understood as being provided by way of example, for the purpose of teaching the general features and principles, but should not be understood as limiting the scope, which is as defined in the appended claims.

1-15. (canceled)

16. A method for data enrichment according to a characteristic using data content from at least two data sources comprising at least one data type, the method comprising:
assigning a trust factor to a data source for the characteristic;
preprocessing data received from the data source according to a data type;
analyzing information comprised by the data with respect to the characteristic; and
applying an enrichment process to select information for data enrichment related to the characteristic based on the analysis of the information and the trust factor.

17. The method of claim 16 wherein the at least one data type comprises data type text, data type structured information, data type image, data type sound, data type video, or a combination thereof.

18. The method of claim 16 wherein the trust factor reflects how trustworthy the data source is with respect to the characteristic.

19. The method of claim 16 wherein the trust factor is determined based on a machine learning model that is continuously trained with data retrieved from the two or more data sources.

20. The method of claim 16 wherein the at least one data type comprises data type text, data type structured information, data type image, data type sound, data type video, and preprocessing data received from the data source according to the data type comprises:
extracting content of the data by at least one of:
for the data type text: applying natural language processing for translation, correction, formatting, speech tagging, and/or feature extraction of the text;
for the data type structured information: organizing content according to tags;
for the data type image: applying at least one of object detection, face detection, object segmentation, and object recognition;
for the data type sound: applying speech recognition and/or natural language processing; and
for the data type video: applying at least one of object detection, face detection, speech recognition, and natural language processing.

21. The method of claim 16 wherein preprocessing the data from the data source according to a data type comprises:
extracting metadata of the data.

22. The method of claim 21 wherein metadata comprises at least one of descriptive metadata relating to at least one of title, subject, genre, and author, rights metadata relating to at least one of title, copyright status, rights holder, and license terms, technical metadata relating to at least one of file types, size, creation date, creation time, type of compression, uniform resource locator, and page rank, preservation metadata relating to an item's place in a hierarchy or in a sequence, and picture metadata relating to at least one of a timestamp, camera properties, resolution, size, and geotag.

23. The method of claim 16 wherein the at least one data type comprises data type text, data type structured information, data type image, data type sound, data type video, and analyzing the information comprised by the data with respect to the characteristic comprises at least one of:
for the data type text: applying natural language processing for analyzing word similarity and/or sentiments of authors;
for the data type image: analyzing detected objects and/or faces with respect to at least one of facial expression, emotion, age, and gender; and
for the structured data type: discovering rules in the structure data.

24. The method of claim 16 wherein analyzing the information comprised by the data with respect to the characteristic comprises:
determining a relevance score for the data with respect to the characteristic and a confidence value of the relevance score being correct.

25. The method of claim 24 wherein the enrichment process is based on a machine learning model, and an input to the machine learning model comprises the relevance score for the data with respect to the characteristic, the confidence value of the information being correct, the trust factor of the data source of the information, a weight factor of the information, and a time stamp.

26. The method of claim 25 wherein the input to the machine learning model comprises further information extracted from metadata.

27. The method of claim 16 wherein applying the enrichment process to select the information for data enrichment related to the characteristic based on the analysis of the information and the trust factor comprises:
determining a probability value for the information for data enrichment being correct; and
in response to the probability value being higher than a threshold value, selecting the information.

28. The method of claim 16 wherein the method is triggered periodically and/or in response to a request for recommendation request concerning the characteristic.

29. A computing apparatus for data enrichment according to a characteristic using data content from at least two data sources comprising at least one data type, the computing apparatus comprising:
one or more processors; and
at least one memory device coupled with the one or more processors,
wherein the at least one memory device contains a plurality of program instructions that, when executed by the one or more processors, cause the computing apparatus to:
assign a trust factor to a data source for the characteristic;
preprocess data received from the data source according to a data type;
analyze information comprised by the data with respect to the characteristic; and
apply an enrichment process to select information for data enrichment related to the characteristic based on the analysis of the information and the trust factor.

30. The computing apparatus of claim 29 wherein the at least one data type comprises data type text, data type structured information, data type image, data type sound, data type video, or a combination thereof.

31. The computing apparatus of claim 29 wherein the trust factor reflects how trustworthy the data source is with respect to the characteristic.

32. The computing apparatus of claim 29 wherein the trust factor is determined based on a machine learning model that is continuously trained with data retrieved from the two or more data sources.

33. The computing apparatus of claim 29 wherein analyze the information comprised by the data with respect to the characteristic comprises:
determine a relevance score for the data with respect to the characteristic and a confidence value of the relevance score being correct.

34. The computing apparatus of claim 33 wherein the enrichment process is based on a machine learning model, and an input to the machine learning model comprises the relevance score for the data with respect to the characteristic, the confidence value of the information being correct, the trust factor of the data source of the information, a weight factor of the information, and a time stamp.

35. A non-transitory computer storage medium encoded with a computer program, the computer program comprising a plurality of program instructions that when executed by one or more processors cause the one or more processors to perform operations for data enrichment according to a characteristic using data content from at least two data sources comprising at least one data type, and the operations comprising:
assign a trust factor to a data source for the characteristic;
preprocess data received from the data source according to a data type;
analyze information comprised by the data with respect to the characteristic; and
apply an enrichment process to select information for data enrichment related to the characteristic based on the analysis of the information and the trust factor.
